(19) United States
(12) Patent Application Publication
(10) Pub. No.: US 2017/0139401 A1
(43) Pub. Date: May 18, 2017

(54) NUMERICAL CONTROL SYSTEM, MACHINE TOOL HAVING NUMERICAL CONTROL SYSTEM, AND DATA STRUCTURE OF MACHINING PROGRAM

(71) Applicant: DMG MORI CO., LTD., Yamatokoriyama-shi (JP)

(72) Inventors: Atsushi HONGO, Sapporo-shi (JP); Sumihiro KIYOTA, Yamatokoriyama-shi (JP); Masakazu TAKAYAMA, Yamatokoriyama-shi (JP); Yuka KIMURA, Sapporo-shi (JP)

(21) Appl. No.: 15/345,839

(22) Filed: Nov. 8, 2016

(30) Foreign Application Priority Data
Nov. 13, 2015 (JP) 2015-222819

(51) Int. Cl. G05B 19/408

(52) U.S. Cl. CPC G05B 19/4083; G05B 2219/32281; G05B 2219/35519

(57) ABSTRACT

A numerical control system, a machine tool having a numerical control system, and a data structure of a machining program, capable of automatically setting a plurality of tailstock settings corresponding to various machining processes, without increasing hardware resources on the numerical control apparatus side, are provided. A numerical control system 1 includes a numerical control apparatus 12 that controls driving of a machine tool 11 provided with a tailstock 10, and an external storage device 13. The external storage device 13 includes a machining program storage unit 14 that stores a machining program having a data structure including job data and setup data associated with a plurality of tailstock settings. The numerical control apparatus 12 includes a tailstock setting buffer 32, an active buffer region selection unit 43, and a tailstock setting writing unit 44.

### BACKGROUND OF THE INVENTION

Field of the Invention

The present invention relates to a numerical control system including a numerical control apparatus that controls driving of a machine tool provided with a tailstock and an external storage device that provides the numerical control apparatus with a machining program, a machine tool having a numerical control system, and a data structure of a machining program.

Description of the Related Art

Conventionally, in a machine tool provided with a tailstock, various types of tailstock settings are used to allow a tailstock spindle to abut an end portion of a workpiece to support it. For example, Japanese Patent Laid-Open No. 8-71805 discloses a numerical control apparatus in which a plurality of normal movement quantities of a tailstock spindle can be stored according to the types of workpieces.

Further, while a plurality of machining processes such as surface machining and rear face machining are required for machining one product conventionally, there is also a case where each of the machining processes further requires a plurality of tailstock settings for rough machining, finishing, and the like. As such, there is a case where a large number of tailstock settings are used properly according to not only the type of workpiece but also respective machining processes.

However, in conventional numerical control apparatuses including the invention described in Japanese Patent Laid-Open No. 8-71805, as a storage means capable of performing reading and writing at a high speed is installed, there is often a case where a sufficient storage capacity is not secured. As such, an attempt to store a large number of tailstock settings in the storage means on the numerical control apparatus side causes a problem that a storage region for storing a machining program is oppressed.

Meanwhile, an attempt to increase the storage capacity by installing more storage means on the numerical control apparatus side causes not only a cost increase. It may also cause deterioration in the processing capability. Accordingly, in a numerical control apparatus, it is desirable to effectively and efficiently utilize the hardware resources installed originally.

The present invention has been made to solve such problems. An object of the present invention is to provide a numerical control system, a machine tool having a numerical control system, and a data structure of a machining program, capable of automatically setting a large number of tailstock settings corresponding to various machining processes, without increasing the hardware resources on the numerical control apparatus side.

### SUMMARY OF THE INVENTION

A numerical control system according to the present invention includes a numerical control apparatus that controls driving of a machine tool provided with a tailstock, and an external storage device that provides the numerical control apparatus with a machining program. The external storage device includes a machining program storage unit that stores a machining program having a data structure including job data corresponding to one product, and setup data included in the job data and corresponding to one machining process. The setup data is associated with a plurality of tailstock settings related to the tailstock. The numerical control apparatus includes a tailstock setting buffer including two or more buffer regions each capable of storing one of the tailstock settings; an active buffer region selection unit that, when machining using one of the tailstock settings stored in an active buffer region of the respective buffer regions is completed, selects a non-active buffer region as a new active buffer region; and a tailstock setting writing unit that, when the active buffer region selection unit selects the new active buffer region, writes one of the tailstock settings corresponding to the next machining to a non-active buffer region.

Further, a machine tool according to the present invention is provided with the numerical control system of the present invention described above.

Further, a data structure of a machining program according to the present invention is a data structure of a machining program for controlling driving of a machine tool provided with a tailstock. The data structure includes job data corresponding to one product, and setup data included in the job data and corresponding to one machining process. The setup data is associated with a plurality of tailstock settings related to the tailstock.

According to the present invention, it is possible to automatically set a large number of tailstock settings corresponding to various machining processes, without increasing the hardware resources on the numerical control apparatus side.

### BRIEF DESCRIPTION OF THE DRAWINGS

FIG. 1 is a block diagram illustrating an embodiment of a numerical control system according to the present invention;

FIG. 2 is a diagram illustrating a configuration of a tailstock in the present embodiment;

FIG. 3 is a flowchart showing processing executed by the numerical control system of the present embodiment; and

FIG. 4 illustrate transitions of tailstock settings stored in respective buffer regions of a tailstock setting buffer in the present embodiment.

### DETAILED DESCRIPTION OF THE PREFERRED EMBODIMENT

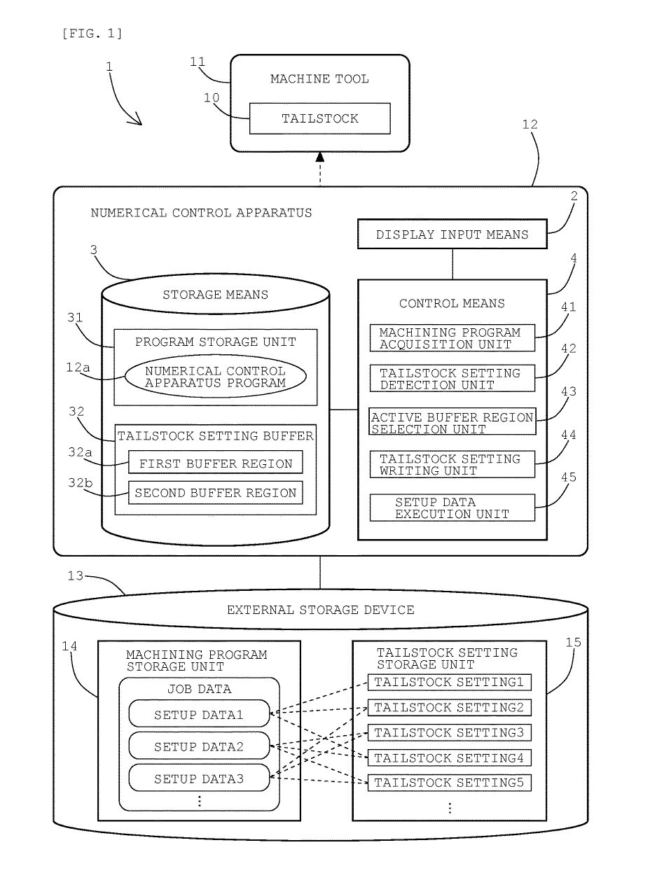

Hereinafter, an embodiment of a numerical control system according to the present invention will be described using the drawings. As shown in FIG. 1, a numerical control system 1 of the present embodiment includes a numerical control apparatus 12 that controls driving of a machine tool 11 provided with a tailstock 10, and an external storage device 13 that provides the numerical control apparatus 12 with a machining program. The respective configurations will be described below in detail.

The machine tool 11 is a machine such as a lathe, a gear cutting machine, or a grinding machine, for performing machining such as cutting, boring, grinding, polishing, rolling, forging, or folding on a workpiece made of metal, wood, stone, resin or the like. In the present embodiment, the machine tool 11 is provided with the tailstock 10 for allowing a tailstock spindle 10a to abut an end portion of a workpiece to support it, based on a drive signal supplied from the numerical control apparatus 12.

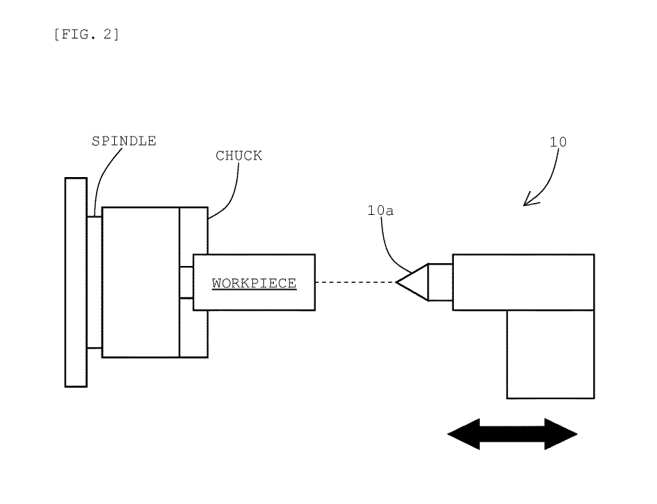

It should be noted that as shown in FIG. 2, the tailstock 10 is configured to be movable along the axial direction of the tailstock spindle 10a, and allow the tailstock spindle 10a to abut a workpiece held by a spindle chuck. Further, in the present embodiment, while the machine tool 11 is assumed to be a lathe provided with the numerical control apparatus 12, the present invention is not limited to this configuration. The machine tool 11 and the numerical control apparatus 12 may be configured separately.

The external storage device 13 is configured of a personal computer, a database server, or the like having a general operating system. In the present embodiment, the external storage device 13 includes a machining program storage unit 14 that stores a machining program and a tailstock setting storage unit 15 that stores tailstock settings, as shown in FIG. 1.

The machining program storage unit 14 stores a machining program for controlling driving of the machine tool 11 provided with the tailstock 10. In the present embodiment, the machining program has a data structure including job data corresponding to one product and a plurality of setup data included in the job data and each corresponding to one machining process, as shown in FIG. 1. Each setup data is associated with a plurality of tailstock settings to be used in a corresponding machining process, with use of tailstock setting IDs.

It should be noted that a machining process corresponding to each setup data includes surface machining, rear face machining, or the like, and machining corresponding to each tailstock setting includes rough machining, finishing, or the like. Although FIG. 1 only shows one unit of job data, a plurality of units of job data are prepared according to the number of products to be machined.

The tailstock setting storage unit 15 stores a plurality of tailstock settings related to the tailstock 10. In the present embodiment, in the tailstock setting storage unit 15, a plurality of tailstock settings are stored according to the type of a product and the types of the machining processes, with tailstock setting IDs provided, as shown in FIG. 1.

It should be noted that tailstock settings include various type of settings related to drive control of the tailstock 10, such as thrust when operating a tailstock, pressing position at preset thrust, approaching position in fast forwarding, retracting position, pressing tolerance, presence/absence of re-chucking (after pressing, whether or not to automatically perform chuck unclamping/clumping operation), re-chucking timer (timer until switching to a clamp command after an unclamp command after re-chucking), for example.

The numerical control apparatus 12 is configured of a computer capable of performing numerical control processing such as computerized numerical control (CNC), and controls the machine tool 11 based on a machining program to allow machining of a workpiece to be performed.

In the present embodiment, the numerical control apparatus 12 includes a display input means 2 for displaying various types of screens and accepting various types of inputs from a user, a storage means 3 for storing various types of data and functioning as a working area when a control means 4 performs arithmetic operation, and the control means 4 for performing various types of arithmetic operation by executing a numerical control apparatus program 12a installed in the storage means 3, as shown in FIG. 1. Hereinafter, the respective constituent means will be described.

The display input means 2 is configured of a touch panel having both a displaying function by means of a liquid crystal panel or the like, and a position input function by means of a touchpad or the like. In the present embodiment, the display input means 2 displays a selection screen for job data and setup data, for example, and accepts selection by a user based on the touched position on the selection screen. While a touch panel is used as the display input means 2 in the present embodiment, a display means such as a liquid crystal display and input means such as a mouse, keyboard, and the like may be provided separately.

The storage means 3 is configured of a hard disk, ROM (Read Only Memory), RAM (Random Access Memory), a flash memory, and the like. As shown in FIG. 1, the storage means 3 includes a program storage unit 31 that stores a numerical control apparatus program 12a, and a tailstock setting buffer 32 that stores tailstock settings.

In the program storage unit 31, a real time operation system (RTOS) is installed. Further, a numerical control apparatus program 12a, for controlling the numerical control apparatus 12 of the present embodiment, is installed in the program storage unit 31. The control means 4 is configured to execute the numerical control apparatus program 12a to thereby cause the computer to function as the respective constituent units described below.

It should be noted that the utilization form of the numerical control apparatus program 12a is not limited to the configuration described above. For example, the numerical control apparatus program 12a may be stored in a computer-readable non-temporary recording medium, such as a CD-ROM or a USB memory, and directly read from the recording medium to be executed. Further, it may be used from an outside server or the like using a cloud computing system, an ASP (Application Service Provider) system, or the like.

The tailstock setting buffer 32 temporarily stores various tailstock settings to be used in the numerical control apparatus 12. In the present embodiment, the tailstock setting buffer 32 includes a first buffer region 32a and a second buffer region 32b, as shown in FIG. 1. Each of the buffer regions is configured to be able to temporarily store one of the tailstock settings. While the tailstock setting buffer 32 includes two buffer regions in the present embodiment, it is not limited to this configuration. Three or more buffer regions may be provided, if they do not oppress the storage region for storing the machining program.

The control means 4 is configured of a CPU (Central Processing Unit) or the like. The control means 4 is configured to execute the numerical control apparatus program 12a installed in the storage means 3 to thereby function as a machining program acquisition unit 41, a tailstock setting detection unit 42, an active buffer region selection unit 43, a tailstock setting writing unit 44, and a setup data execution unit 45, as shown in FIG. 1. The respective constituent units will be described below in more detail.

The machining program acquisition unit 41 acquires a machining program from the machining program storage unit 14 of the external storage device 13. In the present embodiment, the machining program acquisition unit 41 is configured such that when a user selects job data corresponding to a desired product via the display input means 2 and selects one of a plurality of the setup data included in the job data, the machining program acquisition unit 41 acquires the setup data.

The tailstock setting detection unit 42 detects all tailstock settings included in the setup data. In the present embodiment, the tailstock setting detection unit 42 sequentially reads all tailstock setting IDs linked to the setup data acquired by the machining program acquisition unit 41, and lists them as those to be written sequentially into either of the buffer areas.

The active buffer region selection unit 43 is configured to, when machining using a tailstock setting stored in an active buffer region of the respective buffer regions is completed, select a non-active buffer region as a new active buffer region. It should be noted that in the present invention, an active buffer region means a buffer region in which a tailstock setting used in the machining being executed currently is stored.

As the present embodiment has two buffer regions, when the first buffer region 32a is selected as an active buffer region, the second buffer region 32b is a non-active buffer region, while when the second buffer region 32b is selected as an active buffer region, the first buffer region 32a is a non-active buffer region. In the case where three or more buffer regions are included, only one of the buffer regions is selected as an active buffer region, and the other buffer regions are non-active buffer regions.

The tailstock setting writing unit 44 sequentially writes the tailstock settings in the respective buffer regions. In the present embodiment, when any setup data is executed, the tailstock setting writing unit 44 reads, from the tailstock setting storage unit 15, a tailstock setting corresponding to the first tailstock setting ID, of the tailstock setting IDs listed by the tailstock setting detection unit 42, and writes it to either one of the buffer regions. Then, when such a buffer region is selected as an active buffer region, the tailstock setting writing unit 44 reads a tailstock setting corresponding to the next tailstock setting ID from the tailstock setting storage unit 15, and writes it to the other buffer region.

As such, as long as there is an unused tailstock setting ID among the tailstock setting IDs listed by the tailstock setting detection unit 42, when a new active buffer region is selected by the active buffer region selection unit 43, the tailstock setting writing unit 44 writes or overwrites the tailstock setting corresponding to the next machining to the non-active buffer region.

It should be noted that the processing operation by the active buffer region selection unit 43 and the tailstock setting writing unit 44 described above can be realized by designating it using M-code or the like that plays an auxiliary role with respect to G-code of the machining program.

The setup data execution unit 45 sequentially executes setup data. In the present embodiment, setup data is configured such that G-code, M-code, or the like is given to each block constituting a machining program to designate various types of machining operation to be performed by the machine tool 11. Then, the setup data execution unit 45 reads a tailstock setting from an active buffer region based on an instruction of each block, and causes the machining operation to be performed with use of the tailstock setting.

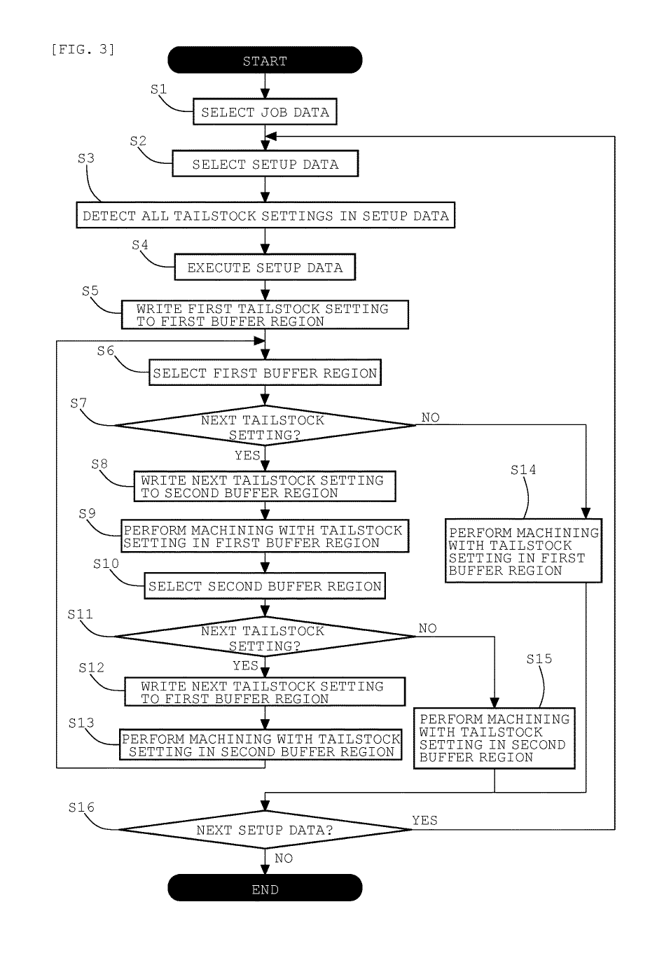

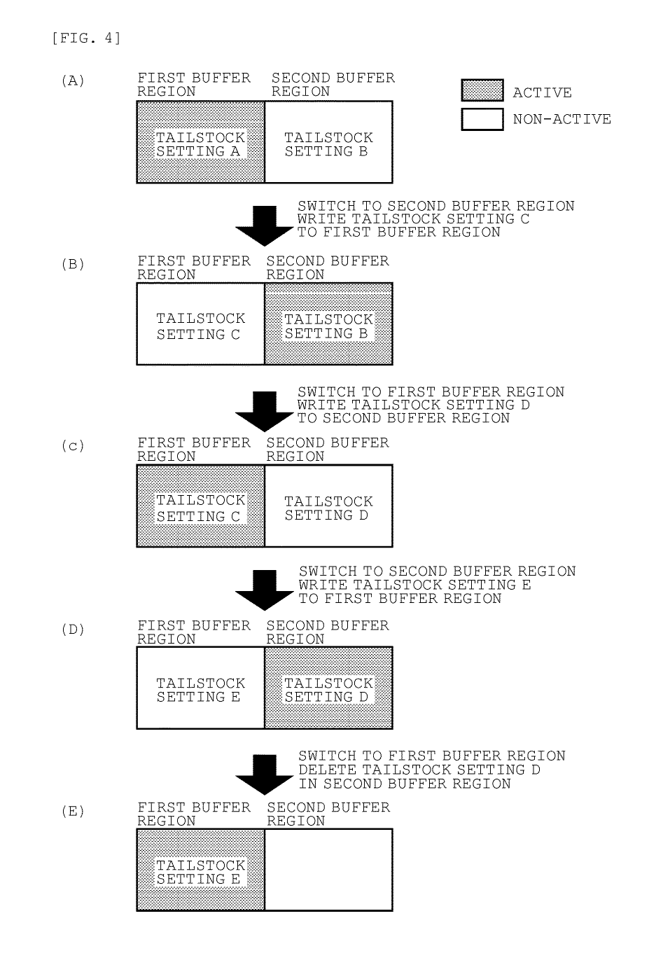

Next, actions of the numerical control system 1, the machine tool 11 provided with the numerical control system 1, and the data structure of the machining program, according to the present embodiment, will be described using FIGS. 3 and 4. The description provided below exemplary illustrates the case where five tailstock settings A to E are associated with the setup data to be executed.

In the case of performing machining of a workpiece by controlling the machine tool 11 by the numerical control system 1 of the present embodiment, a machining program is created to have a data structure including job data and setup data, and is stored in the machining program storage unit 14 in advance, as shown in FIG. 1. With such a data structure, although a manual preparatory work has been required conventionally before starting the next machining process each time one machining process is completed, such a preparatory work is performed automatically. Further, once setup data is created, it is only necessary to make selection from that time on, so that there is no need to input it manually.

As shown in FIG. 3, when job data and setup data are prepared, job data corresponding to a desired product is selected via the display input means 2 (step S1). Thereby, as all setup data included in the job data are shown in a selectable state, one of the setup data is selected (step S2). Thereby, the machining program acquisition unit 41 acquires the setup data from the machining program storage unit 14 of the external storage device 13.

When the setup data is acquired, the tailstock setting detection unit 42 detects all tailstock settings linked to the setup data, and makes a list of them (step S3). In this way, in the present embodiment, all tailstock settings to be used in each setup data are associated in advance. As such, the tailstock settings are also set automatically at the time of preparatory operation performed automatically between respective machining processes.

Then, when the setup data execution unit 45 starts execution of the setup data (step S4), as shown in state (A) in FIG. 4, the tailstock setting writing unit 44 writes a first tailstock setting A to the first buffer region 32a (step S5), and the active buffer region selection unit 43 selects the first buffer region 32a as an active buffer region (step S6). Then, as there is a next tailstock setting B (step S7: YES), the tailstock setting writing unit 44 writes the tailstock setting B to the second buffer region 32b which is a non-active buffer region (step S8). Thereby, the tailstock setting B, corresponding to the next machining, is prepared on the numerical control apparatus 12 side in advance.

Next, when the setup data execution unit 45 performs machining using the tailstock setting A stored in the active buffer region (step S9), the active buffer region selection unit 43 switches the active buffer region to the second buffer region 32b (step S10), as shown in state (B) in FIG. 4. Then, as there is a next tailstock setting C (step S11: YES), the tailstock setting writing unit 44 writes the tailstock setting C to the first buffer region 32a which is a non-active buffer region (step S12). Thereby, the tailstock setting C, corresponding to the next machining, is prepared on the numerical control apparatus 12 side in advance.

Then, when the setup data execution unit 45 performs machining using the tailstock setting B stored in the active buffer region (step S13), the processing returns to step S6, and the processing from step S6 to step S13 described above is looped as long as there is an unused tailstock setting (step S7: YES, step S11: YES).

With the loop processing as described above, the subsequent processing is performed similarly that the first buffer region 32a in which the tailstock setting C is stored is switched to the active buffer region, and a tailstock setting D is written to the second buffer region 32b which is a non-active buffer region (state (C) in FIG. 4). Then, the second buffer region 32b, in which the tailstock setting D is stored, is switched to an active buffer region, and a tailstock setting E is written to the first buffer region 32a which is a non-active buffer region (state (D) FIG. 4). Then, the first buffer region 32a, in which the tailstock setting E is stored, is switched to an active buffer region, and the second buffer region 32b, which is a non-active buffer region, is cleared (state (E) FIG. 4).

As described above, by reading a tailstock setting to be used next and writing it to a non-active buffer region in advance, the numerical control apparatus 12 is able to use a plurality of tailstock settings in one machining process although there are only two buffer regions.

On the other hand, when there is no tailstock setting left in the loop processing (step S7: NO, step S11: NO), machining is performed with the tailstock setting stored in the active buffer region at that time (step S14, step S15), and execution of the setup data is completed. Then, when there is next setup data (step S16: YES), the processing returns to step S2. Meanwhile, when there is no next setup data (step S16: NO), execution of the job data selected at step S1 is completed.

According to the present embodiment as described above, advantageous effects as described below can be achieved.

1. A plurality of tailstock settings can be set automatically corresponding to various machining processes, without increasing the hardware resources on the numerical control apparatus 12 side.

2. As a plurality of tailstock settings can be used in one machining process due to the processing of the software side and the data structure, it is possible to prevent cost increase and deterioration in the processing performance.

3. Preparatory operation can be performed automatically with the data structure including job data and setup data.

4. At the time of preparation, all tailstock settings associated with setup data can be set automatically.

5. Once setup data is created, as it is unnecessary to input it manually from that time on, operation efficiency can be improved.

It should be noted that the numerical control system 1, the machine tool 11 provided with the numerical control system 1, and the data structure of the machining program, according to the present invention, are not limited to the embodiment described above, and can be changed appropriately.

For example, while a machining program having a data structure including job data and setup data is used in the present embodiment described above, an ordinary machining program not having such a data structure can be executed. In that case, tailstock settings not linked to any setup data are stored in the tailstock setting storage unit 15, and such tailstock settings are used.

What is claimed is:

1. A numerical control system comprising:
a numerical control apparatus that controls driving of a machine tool provided with a tailstock, and
an external storage device that provides the numerical control apparatus with a machining program, wherein
the external storage device includes a machining program storage unit that stores a machining program having a data structure including job data corresponding to one product and setup data included in the job data and corresponding to one machining process, the setup data being associated with a plurality of tailstock settings related to the tailstock, and
the numerical control apparatus includes:
a tailstock setting buffer including two or more buffer regions each capable of storing one of the tailstock settings;
an active buffer region selection unit that, when machining using one of the tailstock settings stored in an active buffer region of the respective buffer regions is completed, selects a non-active buffer region as a new active buffer region; and
a tailstock setting writing unit that, when the active buffer region selection unit selects the new active buffer region, writes one of the tailstock settings corresponding to next machining to a non-active buffer region.

2. A machine tool having the numerical control system according to claim 1.

3. A data structure of a machining program for controlling driving of a machine tool provided with a tailstock, the data structure comprising
job data corresponding to one product, and
setup data included in the job data and corresponding to one machining process, wherein
the setup data is associated with a plurality of tailstock settings related to the tailstock.
